(19) United States
(12) Patent Application Publication
(10) Pub. No.: US 2010/0072300 A1
(43) Pub. Date: Mar. 25, 2010

(54) PAINT SPRAYER

(76) Inventors: William S. Miller, Anderson, SC (US); Robert E. McCracken, Anderson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/563,861

(22) Filed: Sep. 21, 2009

Related U.S. Application Data
(60) Provisional application No. 61/099,769, filed on Sep. 24, 2008.

(51) Int. Cl. B05B 9/01

(52) U.S. Cl. 239/332

(57) ABSTRACT

A hand-held power tool includes a housing assembly, a motor supported by the housing assembly, and a drive mechanism. The drive mechanism includes a rotational input and a reciprocating output. The power tool also includes a sprayer assembly including a cylinder and a piston reciprocable within the cylinder in response to the reciprocating output of the drive mechanism from a first direction to an opposite, second direction. The piston is configured to draw fluid into the cylinder when moving in the first direction, and to discharge the fluid from the cylinder when moving in the second direction.

### RELATED APPLICATION

This application claims priority to co-pending U.S. Provisional Patent Application Ser. No. 61/099,769 filed on Sep. 24, 2008, the entire contents of which is incorporated herein by reference.

### BACKGROUND OF THE INVENTION

The invention relates to power tools and, more particularly, to paint sprayers.

Paint sprayers, or buzz guns, are used to quickly and efficiently paint a surface by discharging a mist or spray of paint onto the surface. Existing paint sprayers typically include an air blower mechanism or a solenoid mechanism to draw paint from a canister and discharge the paint through a nozzle. However, paint sprayers with these types of mechanisms often require a large amount of power to operate. As such, existing paint sprayers are typically corded power tools that use alternating current or AC power available in a wall outlet. In addition, existing paint sprayers are typically very noisy during operation and require an operator to thin the paint before using the paint sprayer.

### SUMMARY OF THE INVENTION

The invention provides, in one aspect, a hand-held power tool including a housing assembly, a motor supported by the housing assembly and including an output shaft rotatable about a first axis, and a drive mechanism. The drive mechanism includes a rotational input and a reciprocating output. The power tool further includes a sprayer assembly including a cylinder and a piston reciprocable within the cylinder in response to the reciprocating output of the drive mechanism from a first direction to an opposite, second direction. The piston is configured to draw fluid into the cylinder when moving in the first direction, and to discharge the fluid from the cylinder when moving in the second direction.

The invention provides, in another aspect, a paint sprayer including a housing assembly, a mount supported by the housing assembly, a canister coupled to the mount in which fluid is contained, a motor supported by the housing assembly and having an output shaft rotatable about a first axis, and a drive mechanism. The drive mechanism includes a first gear coupled to the output shaft for co-rotation with the output shaft about the first axis, a second gear supported by the housing assembly for rotation about a second axis that is non-parallel to the first axis. The second gear is driven by the first gear. The drive mechanism also includes a pin extending in a direction parallel with the second axis and co-rotatable with the second gear at a location non-collinear with the second axis, a shaft reciprocable along a third axis that is non-parallel to the second axis, and a yoke coupling the pin and the shaft. The yoke is operable to transfer rotational movement of the pin about the second axis to reciprocating, linear movement of the shaft along the third axis. The power tool further includes a sprayer assembly including a cylinder and a piston reciprocable within the cylinder in response to reciprocation of the shaft from a first direction to an opposite, second direction. The piston is configured to draw fluid from the canister and into the cylinder when moving in the first direction, and to discharge the fluid from the cylinder when moving in the second direction.

Other features and aspects of the invention will become apparent by consideration of the following detailed description and accompanying drawings.

### BRIEF DESCRIPTION OF THE DRAWINGS

FIG. 1 is a front perspective view of a power tool according to an embodiment of the invention

FIG. 2 is a rear perspective view of the power tool of FIG. 1.

FIG. 3 is an exploded, perspective view of the power tool of FIG. 1.

FIG. 4 is an exploded, perspective view of a drive mechanism of the power tool of FIG. 1.

FIG. 5 is a section view of a portion of the power tool of FIG. 1, taken along line 5-5 in FIG. 1, illustrating a piston in a sprayer assembly of the tool drawing fluid from a container into a cylinder.

FIG. 6 is a section view of the portion of the power tool shown in FIG. 5, illustrating the piston discharging the fluid through a nozzle in the sprayer assembly.

FIG. 7 is a cutaway perspective view of a portion of the power tool of FIG. 1, illustrating a flow of pressurized fluid approaching the nozzle.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

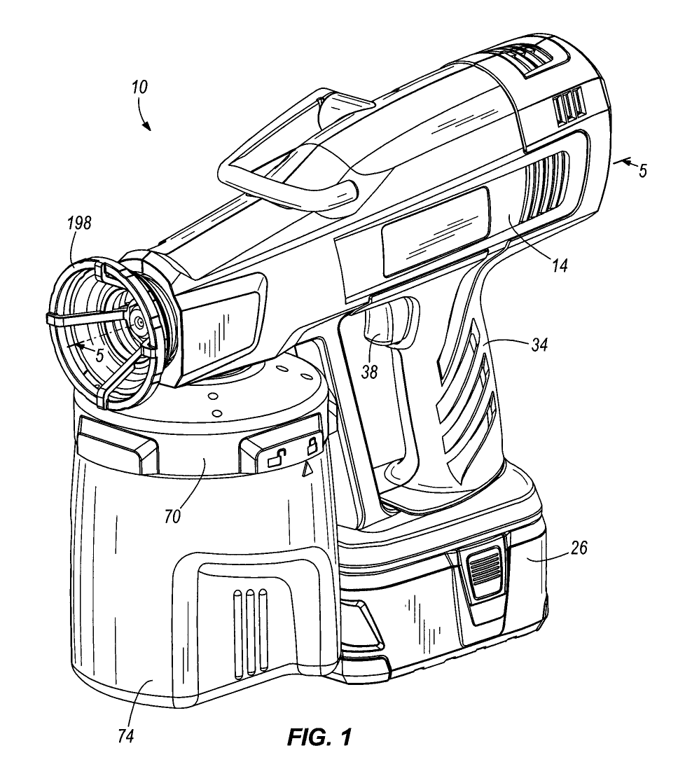

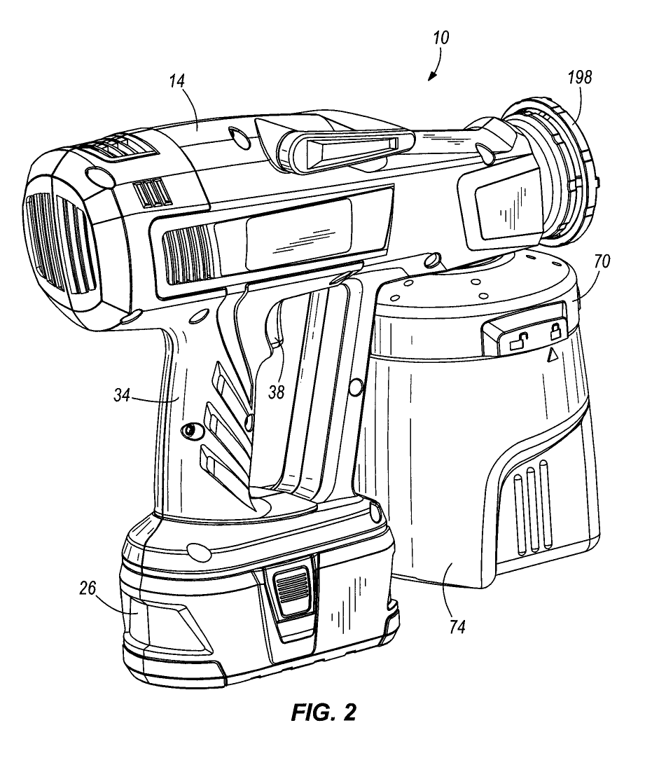

FIGS. 1 and 2 illustrate a hand-held power tool 10 embodying the invention. The illustrated power tool 10 is a paint sprayer, or buzz gun, operable to atomize and spray paint quickly and evenly onto a work surface. Although the power tool 10 is described as being used to spray paint onto a work surface, the power tool 10 may alternatively be used to spray other fluids such as, for example, stain, sealant, soap, cleaners, fertilizer, pesticides, or the like.

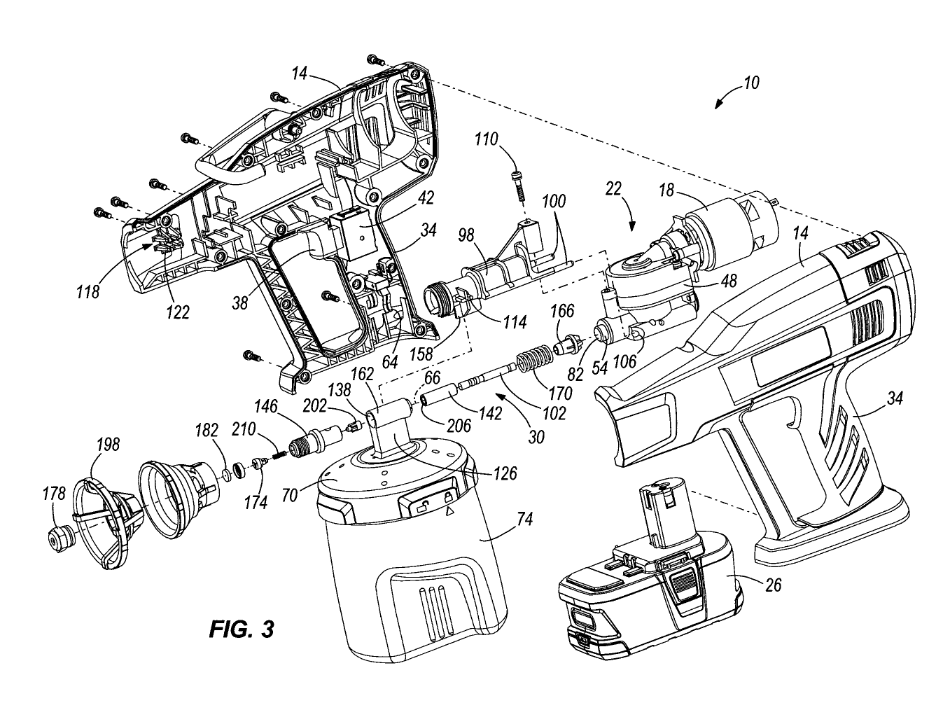

The paint sprayer 10 includes a housing assembly 14, a motor 18 and a drive mechanism 22 (FIG. 3) positioned substantially within the housing assembly 14, a battery pack 26, and a painting or spray assembly 30. The housing assembly 14 is a clamshell-type housing configured to substantially enclose the motor 18, the drive mechanism 22, and other components of the paint sprayer 10. The housing assembly 14 may be composed of a hard plastic material, a metal material, or any other suitable material or combination of materials. As shown in FIGS. 1 and 2, the housing assembly 14 includes a grip portion 34 configured to be held or grasped by an operator during operation of the paint sprayer 10.

A trigger 38 is supported by the housing assembly 14 proximate to the grip portion 34. As shown in FIG. 3, the trigger 38 is coupled to a switch 42 positioned within the grip portion 34. The switch 42 is electrically connected between the motor 18 and the battery pack 26. Depressing the trigger 38 causes the switch 42 to close, thereby providing power to the motor 18 from the battery pack 26 to operate the paint sprayer 10. The switch 42 may include a control circuit (not shown) to control the rotational speed of the motor 18. For example, the switch 42 may be a pressure sensitive switch that rotates the motor 18 at different speeds depending on how hard the trigger 38 is depressed. Alternatively, the switch 42 may be an ON/OFF switch such that the motor 18 either rotates at full speed or does not rotate, regardless of how hard the operator depresses the trigger 38.

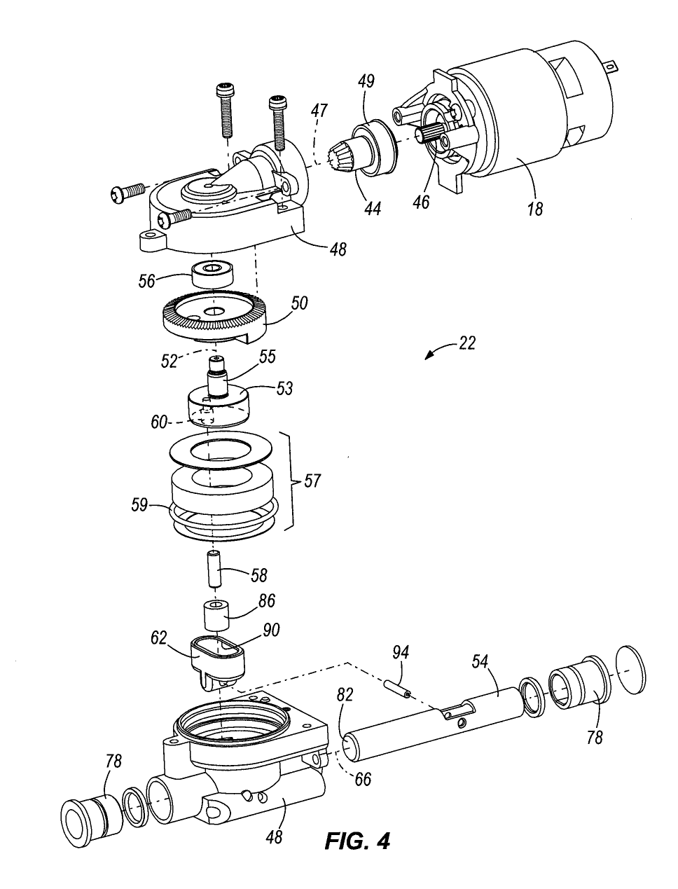

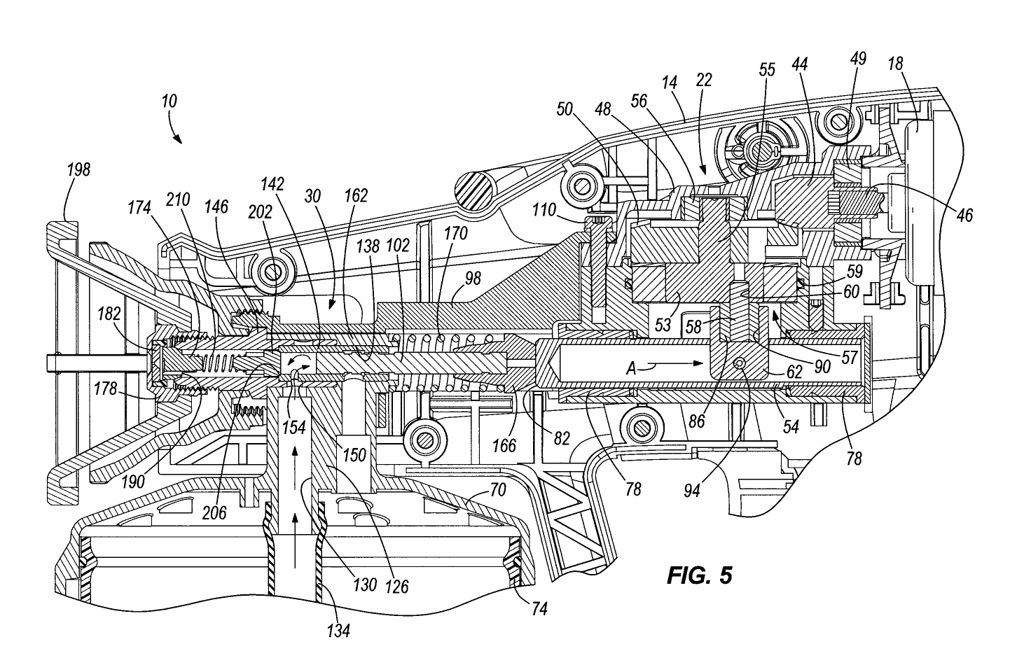

With reference to FIG. 4, the drive mechanism 22 includes a rotational input configured as a first gear or a pinion 44 coupled for co-rotation with an output shaft 46 of the motor 18 about a first axis 47, and a drive housing 48 to which the motor 18 is attached. The pinion 44 is rotatably supported in the drive housing 48 by a bearing 49 (e.g., a roller bearing, ball bearing, a sleeve bearing, a bushing, etc.; see also FIG. 5). The drive mechanism 22 also includes a second gear or bevel gear 50 driven by the pinion 44 and supported in the drive housing 48 for rotation about a second axis 52 that is substantially normal to the first axis 47 (FIG. 4). In the illustrated construction of the drive mechanism 22, the bevel gear 50 is fixed for co-rotation with a hub 53. The hub 53 includes a shaft 55 coaxial with the second axis 52 to which the bevel gear 50 is fixed (e.g., by using an interference fit, by welding, by using a key and keyway arrangement, etc.). An upper end of the shaft 55 is rotatably supported in the drive housing 48 by a bearing 56 (e.g., a roller bearing, ball bearing, a sleeve bearing, a bushing, etc.), and the lower portion of the hub 53 is supported in the drive housing 48 by a thrust bearing assembly 57. As shown in FIGS. 4 and 5, a seal 59 (e.g., an O-ring, etc.) is positioned between the drive housing 48 and the thrust bearing assembly 57 to contain lubricant in the portion of the drive housing 48 in which the pinion 44 and bevel gear 50 are located.

With continued reference to FIGS. 4 and 5, the hub 53 includes an aperture 60 extending in a direction parallel with the second axis 52 at a location non-collinear with the second axis 52, in which a pin 58 is at least partially received (e.g., by using an interference fit, by welding, etc.). Alternatively, the pin 58 may be integrally formed with the hub 53 as a single piece. As a further alternative, the hub 53 may be integrally formed with the bevel gear 50 as a single piece, such that the pin 58 may extend from a face of the gear 50. Because the pin 58 is offset from the second axis 52, the pin 58 rotates about the second axis 52 as the bevel gear 50 rotates. In some embodiments, a series of bevel gears may be employed to transmit rotation of the motor 18 to the pin 58. Alternatively, any of a number of different gear train arrangements may be employed to transfer torque from the motor 18 to the bevel gear 50.

The drive mechanism 22 also includes a reciprocating output configured as a drive shaft 54 that is supported for linear, sliding movement relative to the drive housing 48 along a third axis 66 that is substantially normal to the second axis 52 and substantially parallel with the first axis 47. In the illustrated construction of the paint sprayer 10, the shaft 54 is supported for sliding movement in the drive housing 48 by bearings 78 (e.g., sleeve bearings or bushings). An end 82 of the shaft 54 protrudes from the drive housing 48, the significance of which is discussed below.

With reference to FIG. 4, the drive mechanism 22 further includes a yoke 62 coupling the shaft 54 and the pin 58. In the illustrated construction of the paint sprayer 10, a bearing 86 (e.g., a sleeve bearing or bushing, etc.) is positioned between the pin 58 and the yoke 62 to reduce friction between the pin 58 and the yoke 62. The bearing 86, in turn, is received within a slot 90 in the yoke 62 oriented substantially transversely to the third axis 66. Consequently, the pin 58 and the bearing 86 may reciprocate back and forth within the slot 90 during operation of the drive mechanism 22, which is explained in more detail below. Alternatively, the bearing 86 may be omitted, and the slot 90 may be sized accordingly to directly receive the pin 58 for sliding movement within the slot 90. Also, in the illustrated construction of the paint sprayer 10, the yoke 62 is coupled to the shaft 54 by a pin 94. Alternatively, the yoke 62 may be integrally formed with the shaft 54 as a single piece.

In operation of the drive mechanism 22, the pin 58 and bearing 86 rotate about the second axis 52 while simultaneously reciprocating within the slot 90 of the yoke 62. Specifically, rotation of the pin 58 and the bearing 86 about the second axis 52 can be resolved as velocity vectors lying in an orthogonal coordinate system having one of the axes parallel with the third axis 66. The velocity vectors oriented in the direction of the third axis 66 impart the reciprocating motion to the yoke 62 and shaft 54, while the velocity vectors oriented normal to the third axis 66 cause the pin 58 and bearing 86 to move within the slot 90, without imparting movement to the yoke 62 or shaft 54 along the third axis 66. The combination of the hub 53, the pin 58, the shaft 54, and the yoke 62 may otherwise be identified as a scotch yoke mechanism. Utilizing gears in the drive mechanism 22 helps reduce noise output from the paint sprayer 10 compared to a conventional air blower or solenoid mechanisms because lubricated gears run quieter than a vibrating solenoid or fast-moving air. The illustrated drive mechanism 22 also improves mechanical efficiency of the paint sprayer 10, resulting in a lower power requirement for operation of the sprayer 10 and, thereby, longer battery life.

The gear train, including the pinion 44 and the bevel gear 50, provides an output speed of the hub 53 that is less than the rotational speed of the output shaft 46 of the motor 18 to oscillate or reciprocate the drive shaft 54 at a desired frequency. For example, the operating frequency of the drive shaft 54 (i.e., the frequency at which the drive shaft 54 reciprocates) may be between about 15 Hz and about 60 Hz. In the illustrated construction of the paint sprayer, the operating frequency of the drive shaft 54 is about 48 Hz. However, the paint sprayer 10 may include a speed control knob, or dial, electrically connected to the switch 42 and/or motor 18 to allow an operator to manually adjust the operating frequency of the drive shaft 54.

As shown in FIGS. 1 and 2, the battery pack 26 is supported by the grip portion 34 of the housing assembly 14. The battery pack 26 is electrically connected to the motor 18 through the switch 42 (FIG. 3) to allow the paint sprayer 10 to be used as a hand-held, battery-operated power tool. In the illustrated construction of the paint sprayer 10, the battery pack 26 is an 18.0-volt power tool battery pack and includes ten lithium-ion battery cells. Alternatively, the battery pack 26 may include fewer or more battery cells such that battery pack 26 is a 12.0-volt power tool battery pack, a 14.4-volt power tool battery pack, a 24.0-volt power tool battery pack, or the like. Additionally or alternatively, the battery cells may have chemistries other than lithium-ion such as, for example, nickel cadmium, nickel metal-hydride, or the like. As a further alternative, the paint sprayer 10 may be a corded power tool that runs on AC power, or the paint sprayer 10 may be powered by other suitable power sources (e.g., compressed air).

The battery pack 26 is removably coupled to the grip portion 34 of the housing assembly 14 such that the battery pack 26 may be easily disconnected and/or interchanged with another battery pack during, for example, recharging. A portion of the battery pack 26 is insertable into the grip portion 34 to electrically connect the battery pack 26 to the switch 42 via contacts 64 (FIG. 3) and to secure the battery pack 26 to the housing assembly 14. Alternatively, the battery pack 26 may be connected to the grip portion 34 using other suitable coupling means such as, for example, sliding or rotating the battery pack 26 relative to the housing assembly 14. As a further alternative, the battery pack 26 may be a dedicated, non-removable battery, or other type of power source, contained substantially within the housing assembly 14.

With reference to FIG. 3, the spray assembly 30 is coupled to the housing assembly 14 via a bracket 98, which is also coupled to the drive housing 48 to align some of the components of the spray assembly 30 with some of the components of the drive mechanism 22. Specifically, the bracket 98 includes a plurality of stems 100 extending from a rear portion of the bracket 98 that are received within respective apertures 106 in the drive housing 48 (e.g., using an interference fit). A fastener 110 secures the rear portion of the bracket 98 to the drive housing 48. The bracket 98 also includes laterally-extending ribs 114 extending from each side of the bracket 98. The ribs 114 are received within respective slots 118 defined by corresponding inwardly-extending ribs 122 on each of the shells of the housing assembly 14. As such, when the ribs 114 are received within the respective slots 118, and the shells of the housing assembly 14 are fastened together, the ribs 114 on the bracket 98 interlock with the ribs 122 on the opposed shells of the housing assembly 14, thereby securing the bracket 98 and the drive housing 48 to the housing assembly 14.

With continued reference to FIG. 3, the spray assembly 30 includes a body or mount 70 and a fluid-containing canister 74 coupled to the mount 70. In the illustrated construction of the paint sprayer 10, the canister 74 is coupled to the mount 70 using a quick-lock arrangement (e.g., a protrusion sliding in a groove), such that the canister 74 is rotatable relative to the mount 70 between a locked configuration, in which the canister 74 is secured to the mount 70, and an unlocked configuration, in which the canister 74 may be removed from the mount 70. The canister 74 may be rotated through an angle of about 30 degrees or less relative to the mount 70 between the locked and unlocked configurations. Alternatively, the canister 74 may be removably coupled to the mount 70 using any of a number of different structural arrangements. In the illustrated construction of the paint sprayer 10, the canister 74 is made from a semi-translucent plastic material. Alternatively, the canister 74 may be made from other suitable materials. As a further alternative, the canister 74 may be omitted, and a continuous feed hose or tube may be utilized to fluidly communicate the spray assembly 30 with a bulk source of paint or other fluid.

The mount 70 includes a neck 126 having an internal passageway 130 (FIG. 5) in fluid communication with the interior of the canister 74 when the canister 74 is coupled to the mount 70. In the illustrated construction of the paint sprayer 10, a siphon tube 134 is coupled to the mount 70 and extends downwardly into the canister 74. Although not shown, a filter may be coupled to the distal end of the tube 134. In the illustrated construction, the siphon tube 134 has a rigid construction and is rotatably coupled to the mount 70 to facilitate placement of the filter within the interior of the canister 74 at any location proximate the lower edge of the canister 74 to ensure that substantially all of the paint or other fluid may be drained from the canister 74 during operation of the sprayer 10.

With reference to FIG. 3, the neck 126 also includes an aperture 138 in which a cylinder 142 is received and in which an outlet conduit 146 is at least partially received. The outlet conduit 146 and the cylinder 142 include respective apertures 150, 154 to fluidly communicate the passageway 130 in the mount 70 with the interior of the cylinder 142. In the illustrated construction of the paint sprayer 10, the bracket 98 supports the mount 70 via the neck 126. Specifically, the bracket 98 includes spaced tabs 158 that, when the bracket 98 is secured between the shells of the housing assembly 14, are pinched together to grasp a cylindrical upper portion 162 of the neck 126. As a result, the mount 70 is securely fixed to the housing assembly 14.

With continued reference to FIG. 3, the spray assembly 30 also includes a piston 102 partially supported in the cylinder 142 for reciprocating movement relative to the cylinder 142 in response to reciprocating movement of the drive shaft 54. In the illustrated construction of the paint sprayer 10, a bumper 166 is coupled to an end of the piston 102 proximate the drive shaft 54, and a resilient member (e.g., a compression spring 170) is positioned between the bumper 166 and the cylindrical outer portion 162 of the mount 70 to bias the piston 102 toward the end 82 of the drive shaft 54. As a result, the bumper 166 is substantially maintained in engagement with the end 82 of the drive shaft 54 during reciprocation of the piston 102 and the drive shaft 54. Alternatively, the drive shaft 54 may be fixed to the piston 102 by, for example, fasteners, adhesives, welding, brazing, or the like. Additionally or alternatively, the drive shaft 54 and the piston 102 may be connected by mechanical fittings such as a tongue and groove connection, a beveled connection, a slot and groove connection, or the like. In other constructions of the paint sprayer 10, the piston 102 and the drive shaft 54 may be integrally formed or machined as a single piece. In such a construction, the spring 170 may be omitted.

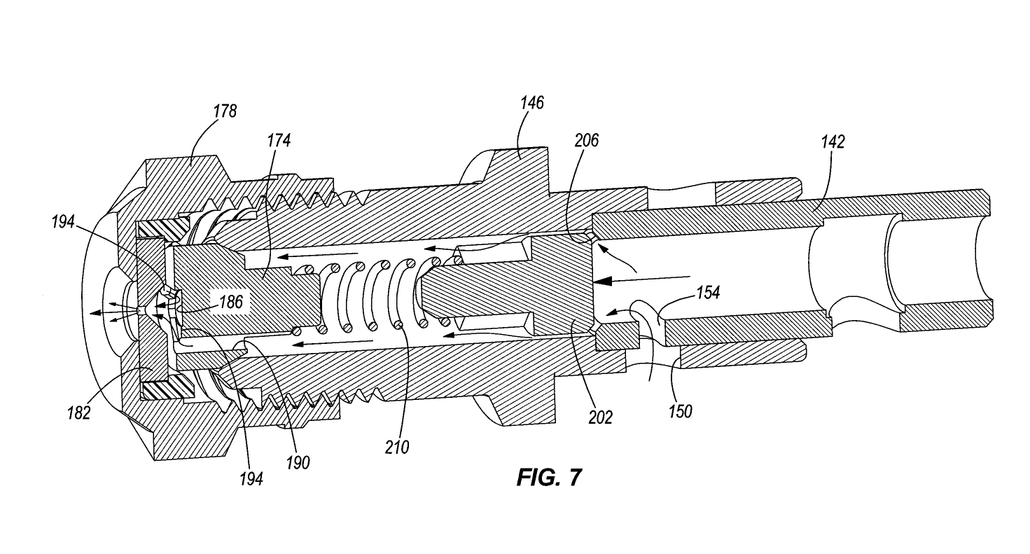

With reference to FIGS. 3 and 5, the spray assembly 30 further includes a body or an atomizer tip 174 disposed proximate the end of the outlet conduit 146. In the illustrated construction of the paint sprayer 10, the atomizer tip 174 is clamped to the end of the outlet conduit 146 by an end cap 178 threaded to the end of the outlet conduit 146, and a nozzle 182 disposed between the end cap 178 and the atomizer tip 174. As shown in FIG. 7, the atomizer tip 174 includes a recess 186 in the end of the tip 174 that is in facing relationship with the nozzle 182. The tip 174 also includes axially-extending passageways 190 and corresponding radially-extending passageways 194, each of which is fluidly connected to at least one of the axially-extending passageways 190. The radially-extending passageways 194, in turn, open into the recess 186. The atomizer tip 174 and the configuration of the passageways 190, 194 facilitate the formulation of turbulence in the paint or other fluid passing through the tip 174, thereby enhancing the atomization of the paint or other fluid ejected through the nozzle 182.

As discussed above, the nozzle 182, in conjunction with the atomizer tip 174, increases the atomization of the discharged paint from the paint sprayer 10 to provide a substantially even or uniform coating of paint over a work surface. The nozzle 182 may be configured to spray the paint in a generally conical pattern. Alternatively, the nozzle 182 may be configured to spray the paint in any of a number of different patterns or shapes. The nozzle 182 may also be interchangeable with other nozzles to change the shape and/or size of the spray area on the work surface. Alternatively, the nozzle 182 may be adjustable by an operator to adjust the spray pattern (e.g., between a conical, horizontal, or vertical spray pattern) to vary the size of the spray area on the work surface. In such a construction of the paint sprayer 10, the spray pattern of the nozzle 182 may be adjustable by rotating or axially displacing a nozzle guard 198 surrounding the nozzle 182.

With reference to FIGS. 3 and 5, the spray assembly 30 further includes a check valve 202 biased against an outlet end 206 of the cylinder 142 to substantially prevent air from being drawn into the cylinder 142 when the piston 102 and drive shaft 54 are moving rearwardly or retracting to draw paint from the canister 74 into the cylinder 142. A resilient member (e.g., a compression spring 210) is positioned between the atomizer tip 174 and the check valve 202 to bias the check valve 202 to the position shown in FIG. 5 (i.e., against the outlet end 206 of the cylinder 142).

In operation of the paint sprayer 10, depressing the trigger 38 actuates or closes the switch 42, thereby electrically connecting the motor 18 with the battery pack 26 to drive the motor 18. Torque from the motor 18 is transferred from the pinion 44 to the bevel gear 50 and hub 53 which, in conjunction with the yoke 62, converts the torque provided by the motor 18 to an oscillating, linear force to reciprocate the drive shaft 54 in the drive housing 48.

With reference to FIG. 5, as the drive shaft 54 retracts into the drive housing 48 (i.e., moves in the direction of arrow A), the spring 170 substantially maintains the bumper 166 engaged with the end 82 of the shaft 54, thereby causing the piston 102 to move relative to the cylinder 142 in the direction of arrow A with the drive shaft 54. At this time, the check valve 202 remains engaged with the outlet end 206 of the cylinder 142 to prevent air from being drawn into the cylinder 142 past the check valve 202. As the aperture 154 in the cylinder 142 is unshrouded by the piston 102 during its movement in the direction of arrow A, a vacuum is created in the cylinder 142 and the passageway 130 which, in turn, draws paint or other fluid from the canister 74 into the passageway 130, through the respective apertures 150, 154 in the outlet conduit 146 and the cylinder 142, and into the cylinder 142.

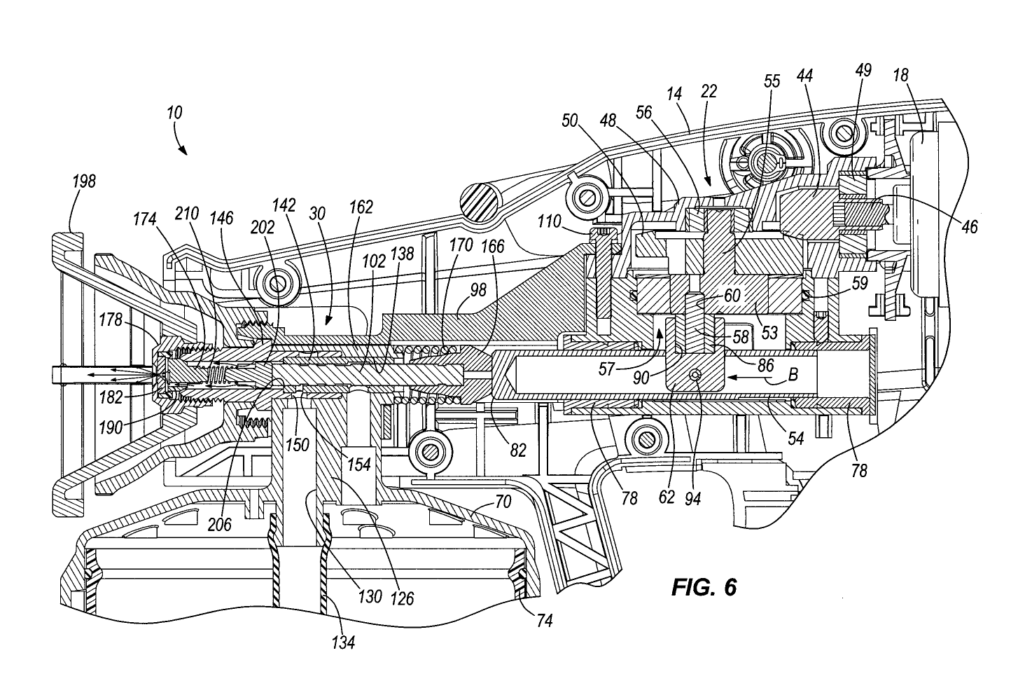

At the completion of the retraction stroke of the drive shaft 54, the yoke 62 pushes the drive shaft 54 in the direction of arrow B (FIG. 6). As the bumper 166 is engaged with the end 82 of the drive shaft 54, movement of the drive shaft 54 in the direction of arrow B also moves the piston 102 in the direction of arrow B to compress the spring 170. The discrete charge or amount of paint or other fluid that had been drawn into the cylinder 142 during the immediately preceding retraction stroke of the drive shaft 54 and piston 102 is compressed by the piston 102 as it moves through the cylinder 142 toward the check valve 202. The resultant pressurized paint or other fluid has a dynamic pressure sufficient to overcome the bias of the spring 210 and unseat the check valve 202 from the outlet end 206 of the cylinder 142, thereby allowing the pressurized paint or other fluid to enter the interior of the outlet conduit 146. In the illustrated construction of the paint sprayer 10, the check valve 202 is engaged by the piston 102 toward the completion of its extension stroke in the direction of arrow B to maintain the check valve 202 in an open configuration. Alternatively, the stroke of the drive shaft 54 and piston 102 may be shortened such that the piston 102 does not contact or engage the check valve 202 toward the completion of the extension stroke of the piston 102.

With reference to FIG. 7, the pressurized paint or other fluid is shown flowing through the interior of the outlet conduit 146. The pressurized paint or other fluid flows through the axially-extending passageways 190 and the radially-extending passageways 194 in the atomizer tip 174 in series, then converges and swirls in the recess 186 prior to being ejected from the nozzle 182. As discussed above, the atomizer tip 174 facilitates the formulation of turbulence in the paint or other fluid passing through the tip 174, thereby enhancing the atomization of the paint or other fluid as it is ejected through the nozzle 182.

The drive mechanism 22 and spray assembly 30 generate sufficient force to discharge the paint from the nozzle 182 without thinning or diluting the paint beforehand. Continued reciprocation of the piston 102 causes continued movement of the check valve 202 between open and closed positions. Paint is therefore continuously and evenly sprayed from the nozzle 182 until the operator releases the trigger 38 or the canister 74 runs out of paint. The motor 18 may include a brake to actively stop reciprocation of the drive shaft 54 and the piston 102 when the trigger 38 is released to inhibit the discharge of paint as the motor 18 slows down.

In other constructions of the paint sprayer 10, the drive shaft 54 or the piston 102 may include a threaded stop ring (not shown) that provides a physical stop for the shaft 54 and the piston 102. The position of the stop ring may be adjustable along the length of the drive shaft 54 or the piston 102 such that the operator may shorten or lengthen the stroke of the shaft 54 and the piston 102, thereby adjusting the discrete amount of paint or other fluid that the paint sprayer 10 expels per stroke of the piston 102. Alternatively, other suitable stroke length-limiting members or mechanisms may be employed.

The paint sprayer 10 may include a speed control knob to allow an operator to adjust the operating frequency of the drive shaft 54 and the piston 102. By adjusting the operating frequency and/or the stroke of the piston 102, the operator can control the atomization and the amount of the paint that is discharged from the paint sprayer 10. For example, increasing the operating frequency of the shaft 54 and the piston 102 decreases the size of paint droplets discharged from the nozzle 182 (i.e., increases atomization), while increasing the stroke of the shaft 54 and the piston 102 increases the amount of paint that is discharged per stroke of the piston 102. The stroke of the drive shaft 54 during reciprocation may be between about 0.146 inches and about 0.200 inches. Alternatively, the stroke of the drive shaft 54 may be less than about 0.146 inches, or greater than about 0.200 inches.

In another construction of the paint sprayer 10, the drive mechanism 22 may be replaced by an electric solenoid. In such a construction, the solenoid may include an electrically-powered coil to create a magnetic field, and the piston 102 may include a ferrous metallic element that is moved toward and/or away from the nozzle 182 when the magnetic field is activated. The solenoid may be a double-acting solenoid that moves the piston 102 in both directions relative to the nozzle 182. Alternatively, the solenoid may be a single-acting solenoid that only moves the piston 102 in one direction relative to the nozzle 182. In such a construction, the spring 170 shown in FIGS. 5 and 6 may be employed to bias the piston 102 in the other direction relative to the nozzle 182. A circuit or microprocessor may also be employed to selectively power (i.e., temporarily interrupt the DC power from the battery pack 26) the double-acting or the single-acting solenoid at the desired operating frequency to reciprocate the piston 102.

In yet other constructions of the paint sprayer 10, the drive mechanism 22 may include a cam member to engage and drive the piston 102. The cam member may be coupled to, for example, the bevel gear 50 and/or the hub 53 to reciprocate the piston 102 at the desired operating frequency. Alternatively, the drive mechanism 22 may include a chain and sprocket mechanism, a belt and pulley mechanism, a rack and pinion arrangement, a direct drive, clutches, hydraulic actuators, or the like to reciprocate the piston 102 and/or the drive shaft 54.

Various features of the invention are set forth in the following claims.

What is claimed is:

1. A hand-held power tool comprising:
a housing assembly;
a motor supported by the housing assembly, the motor including an output shaft rotatable about a first axis;
a drive mechanism including a rotational input and a reciprocating output; and
a sprayer assembly including
a cylinder, and
a piston reciprocable within the cylinder in response to the reciprocating output of the drive mechanism from a first direction to an opposite, second direction,
wherein the piston is configured to draw fluid into the cylinder when moving in the first direction, and wherein the piston is configured to discharge the fluid from the cylinder when moving in the second direction.

2. The power tool of claim 1, wherein the sprayer assembly further includes
a mount supported by the housing assembly, and
a canister coupled to the mount in which the fluid is contained.

3. The power tool of claim 2, wherein the mount includes a passageway fluidly communicating an interior of the canister with an interior of the cylinder.

4. The power tool of claim 3, wherein the cylinder includes an aperture fluidly communicating the passageway and the interior of the cylinder.

5. The power tool of claim 4, wherein the piston is configured to draw fluid from the canister, through the passageway, through the aperture, and into the cylinder when moving in the first direction.

6. The power tool of claim 3, wherein the sprayer assembly includes a hose extending from the mount into the container, and wherein an interior of the hose is in fluid communication with the passageway.

7. The power tool of claim 2, wherein the cylinder is positioned within the mount.

8. The power tool of claim 2, wherein the drive mechanism includes a drive housing, and wherein the power tool further includes a bracket coupling the drive housing and the mount.

9. The power tool of claim 1, wherein the sprayer assembly includes a resilient member biasing the piston in the first direction.

10. The power tool of claim 1, wherein the sprayer assembly includes a nozzle through which the fluid is discharged.

11. The power tool of claim 10, wherein the sprayer assembly includes a body positioned upstream and adjacent the nozzle, wherein the body includes an axially-oriented, first passageway and a radially-oriented, second passageway in fluid communication with the first passageway, and wherein the first and second passageways are configured to increase the turbulence of pressurized fluid flowing through the first and second passageways prior to being discharged through the nozzle.

12. The power tool of claim 10, wherein the sprayer assembly includes a check valve positioned between the cylinder and the nozzle, and wherein the check valve is biased toward an end of the cylinder.

13. The power tool of claim 1, wherein the rotational input of the drive mechanism includes a first gear coupled to the output shaft for co-rotation with the output shaft about the first axis.

14. The power tool of claim 13, wherein the drive mechanism includes
a second gear supported by the housing assembly for rotation about a second axis that is non-parallel to the first axis, the second gear being driven by the first gear, and
a pin extending in a direction parallel with the second axis and co-rotatable with the second gear at a location non-collinear with the second axis.

15. The power tool of claim 14, wherein the rotational output of the drive mechanism includes a shaft reciprocable along a third axis that is non-parallel to the second axis, and wherein the drive mechanism further includes a yoke coupling the pin and the shaft, the yoke operable to transfer rotational movement of the pin about the second axis to reciprocating, linear movement of the shaft along the third axis.

16. The power tool of claim 15, wherein the drive mechanism includes a pin coupling the yoke to the shaft.

17. The power tool of claim 15, wherein the yoke includes a slot oriented substantially normal to the third axis.

18. The power tool of claim 17, wherein the drive mechanism includes a bearing coupled between the pin and the yoke, and wherein the bearing is linearly movable within the slot during rotation of the pin about the second axis.

19. The power tool of claim 15, wherein the drive mechanism includes a hub coupling the second gear and the pin, and wherein the hub includes a shaft coaxial with the second axis to which the second gear is fixed.

20. The power tool of claim 19, wherein the hub includes an aperture extending in a direction parallel with the second axis at a location non-collinear with the second axis, and wherein the pin is at least partially received within the aperture.

21. The power tool of claim 15, wherein the first gear is a pinion, and wherein the second gear is a bevel gear.

22. The power tool of claim 15, wherein the second axis is oriented substantially normal to the first axis.

23. The power tool of claim 22, wherein the third axis is oriented substantially parallel to the first axis.

24. The power tool of claim 1, wherein the motor is an electric motor, and wherein the power tool further includes a battery pack supported by the housing assembly and selectively electrically connected to the motor.

25. The power tool of claim 24, wherein the battery pack is removably coupled to a grip portion of the housing assembly.

26. A paint sprayer comprising:
a housing assembly;
a mount supported by the housing assembly;
a canister coupled to the mount in which fluid is contained;
a motor supported by the housing assembly, the motor including an output shaft rotatable about a first axis;
a drive mechanism including
a first gear coupled to the output shaft for co-rotation with the output shaft about the first axis,
a second gear supported by the housing assembly for rotation about a second axis that is non-parallel to the first axis, the second gear being driven by the first gear,
a pin extending in a direction parallel with the second axis and co-rotatable with the second gear at a location non-collinear with the second axis,
a shaft reciprocable along a third axis that is non-parallel to the second axis, and
a yoke coupling the pin and the shaft, the yoke operable to transfer rotational movement of the pin about the second axis to reciprocating, linear movement of the shaft along the third axis; and
a sprayer assembly including
a cylinder, and
a piston reciprocable within the cylinder in response to reciprocation of the shaft from a first direction to an opposite, second direction,
wherein the piston is configured to draw fluid from the canister and into the cylinder when moving in the first direction, and wherein the piston is configured to discharge the fluid from the cylinder when moving in the second direction.
